(19) United States
(12) Patent Application Publication
(10) Pub. No.: US 2022/0284254 A1
(43) Pub. Date: Sep. 8, 2022

(54) RECONFIGURABLE INTERACTION BADGE

(71) Applicant: Satellite Displays Inc., New York, NY (US)

(72) Inventors: Peter Sprague, Lenox, MA (US); Raymond S. Miles, Woodenville, WA (US); Michael G. Williston, Long Branch, NJ (US)

(21) Appl. No.: 17/636,329

(22) PCT Filed: Aug. 24, 2020
(86) PCT No.: PCT/US2020/047583

§ 371 Date: Feb. 17, 2022

Related U.S. Application Data
(60) Provisional application No. 62/890,740, filed on Aug. 23, 2019.

(51) Int. Cl. G06K 19/077; G06V 40/16; G06K 19/02

(52) U.S. Cl. CPC G06K 19/07707; G06K 19/07711; G06V 40/172; G06K 19/07705; G06K 19/025

(57) ABSTRACT

An interaction badge is provided that can be reconfigured as necessary to display or otherwise provide identification information or credentials for a specific application. The interaction badge can also provide control or access to when and where the information provided by the badge is accessed. Additionally, the interaction badge can provide additional functionality for a wearer such as location and interaction tracking, audio recording, and language translation.

### CROSS-REFERENCE TO RELATED APPLICATION

This application claims priority to, and the benefit of, co-pending U.S. Provisional Application No. 62/890,740, filed Aug. 23, 2019, for all subject matter common to both applications. The disclosure of said provisional application is hereby incorporated by reference in its entirety.

### FIELD OF THE INVENTION

The present invention relates to a badge having electronic capabilities suitable for enhanced functionality. In particular, the present invention relates to a reconfigurable interaction badge that displays information in real-time, such as identification and related information of the wearer, or textual or symbolic representation of audible speech of the wearer and/or an individual with whom they are conversing, as well supporting additional functionality.

### BACKGROUND

The use of badges is common in industry. Employees of companies are issued badges to assist with identification when interacting with customers or to verifying employment or access to a company or facility. Likewise, identification badges are issued to attendees of conferences, conventions, and trade shows to provide identification and credentials for the wearer. Traditional identification badges typically identify the wearer using static text and images. Provided information typically includes: name, organization affiliation, and a photo that is printed on the badge. For conferences, conventions, and trade shows the badge may further include the identification of the event the badge is being used at. Some badges further include Radio Frequency Identification (RFID) or other electronic hardware that allows tracking and verification electronically such as providing access to a facility or event.

However, existing identification badge products experience some shortcomings. Firstly, the information provided by the badge is static in nature. That is, the information is printed or otherwise embedded on the badge in a permanent nature. If the information on the badge needs to be changed, typically a new badge has to be created. Secondly, since the badge is typically created or issued by an entity other than the wearer, the wearer may have minimal input or control over what information is displayed on or otherwise provided by the identification badge. Relating back to the first issue of permanence, this can lead to unnecessary frustration when inaccurate information is displayed or provided by the badge. Thirdly, most of the features or utility of the identification badges are provided for the benefit for people or entities other than the wearer of the badge. That is, the name, company affiliation, picture, and even electronic hardware such as RFID are provided to assist other people or entities to identify the wearer of the badge to determine if they are the appropriate individual for an interaction or admittance to an area or event. In the case of tracking electronics, the company or event issuing the badge tracks the wearer of the badge such as what locations were visited and at what time. The person wearing the badge is given little or no access to or control of the information provided by the badge, including when or how it is used.

Additionally, it is known that a large percentage of communication involves body language, along with how one speaks, and what they are saying, to have a complete understanding of what is being communicated. For those who are hearing impaired, the process of sign language takes away from these other non-verbal cues because those conversing are focused on hands rather than faces. Likewise, when two people are attempting to converse, but they do not speak the same language, there is intense focus on other cues in trying to figure out what the other person is saying, which results in missing some of the other conversation cues. Traditionally, there are five established learning styles: visual, auditory, written, kinesthetic and multimodal. Combining different methodologies, for example spoken word plus reading (via closed captions) can improve comprehension.

Further, in a world ever more concerned with preventing the spread of infectious diseases, the wearing of masks is becoming more commonplace. Unfortunately, a downside of such masks is that they interfere with communication. Speech can be muffled and reading lips or facial expressions is nearly impossible. These problems are exacerbated as, many of the individuals required to wear masks, such as medical professions, need to communicate effectively to address a patient's issues.

### SUMMARY

There is a need for a badge having electronic capabilities that is easy to reconfigure as needed to correctly identify and credential the wearer of the badge, and/or that displays information in real-time, such as identification and related information of the wearer, or textual or symbolic representation of audible speech of the wearer and/or an individual with whom they are conversing, including translation of different languages. The present invention is directed toward further solutions to address these needs, in addition to having other desirable characteristics. Specifically, an interaction badge is provided that can be reconfigured as necessary to display or otherwise provide identification information or credentials for a specific application. The interaction badge can also provide control or access to when and where the information provided by the badge is accessed. Additionally, the interaction badge can provide additional functionality for a wearer such as location and interaction tracking, audio recording, video or image capture, audio-to-text, and real-time language translation.

In accordance with example embodiments of the present invention, a reconfigurable interaction badge is provided. The badge includes a display, a processor, a memory store, a power store, a radio frequency transceiver, a short-range wireless transceiver, and a microphone. The display is for displaying data or information. The processor is in electronic communication with the display and is configured to provide data for output on the display. The memory store is in electronic communication with the processor and is configured to hold instructions and data for execution by the processor. The power store provides power to the processor and display. The radio frequency identification (RFID) transceiver is in electronic communication with the processor and is configured to transmit identification data. The short-range wireless transceiver is in electronic communication with the processor and is configured to transmit and receive data. The microphone is in electronic communication with the processor and is configured to receive audio signals.

In accordance with certain aspects of the invention, the display comprises an electronic-paper (e-paper) display. In certain aspects, the e-paper display has a refresh rate of about once per second. In some such aspects, the refresh rate is three times per second.

In accordance with certain aspects of the invention, the power store comprises radio frequency energy. In accordance with other aspects, the power store is a battery. In some such aspects, the battery is a rechargeable battery.

In accordance with certain aspects of the invention, the processor is further configured log each use of the RFID transceiver and store data in the memory.

In accordance with certain aspects of the invention, the reconfigurable interaction badge includes a data port. In certain aspects, the data port is a USB port.

In accordance with certain aspects of the invention, the processor is further configured to receive speech from microphone and output text on the display. In some such aspects; outputting text involves transmitting audio information received from the microphone to an external connected device for processing and conversion using the short-range wireless transceiver, receiving text from the external connected device using the short-range wireless transceiver, and outputting the text on the display. In still further aspects, the text received from the external connected device comprises text that is a closed-captioned text conversion of the audio information. In other further aspects, the text received from the external connected device comprises text that is a language translation text conversion of the audio information.

In accordance with certain aspects of the invention, the interaction badge further includes a GPS receiver in electronic communication with the processor.

In accordance with certain aspects of the invention, the interaction badge further includes a camera in electronic communication with the processor.

In accordance with certain aspects of the invention, the RFID transceiver communicates using Near Field Communication (NFC).

In accordance with certain aspects of the invention, the interaction badge further includes a housing holding the display, processor, memory, transceivers, and microphone.

In accordance with certain aspects of the invention, the interaction badge further includes a switch for activating functionality of interaction badge.

In accordance with certain aspects of the invention, the interaction badge further includes a vibration mechanism disposed to cause the badge to vibrate.

In accordance with certain aspects of the present invention, the interaction badge further includes an indicator light. In certain aspects, indicator light can include color illumination, where the color can be selected or otherwise changed. For example, the color can include red, green, blue, and variations thereof. In some aspects, the indicator light includes a light emitter disposed inside the badge optically coupled with a light transmission fiber coupled with a light box disposed at a corner of the interaction badge enabling the indicator light to be viewable by the user and a third party.

In accordance with certain aspects of the present invention, the microphone of the interaction badge is directional and targeted outwardly form the interaction badge away from a user of the badge enabling receipt of audio from a third party. In accordance with certain aspects of the present invention, the interaction badge further includes a second microphone targeted upwardly toward a mouth of the user of the badge enabling receipt of audio from the user.

In accordance with example embodiments of the present invention, a method of using a reconfigurable interaction badge is provided. The method involves: providing a reconfigurable interaction badge, uploading data into the memory of the reconfigurable interaction badge for execution by the processor to display identification information on the display; and displaying data or information on the display of the reconfigurable interaction badge.

In accordance with certain aspects of the invention, the data or information includes one or more of: a name, a photo, a company affiliation, a graphic, text, speech-to text display, and speech-to-text language translation.

In accordance with certain aspects of the invention, the uploading is performed using a data port of the reconfigurable interaction badge. In other aspects, the uploading is performed using the short-range wireless transceiver of the reconfigurable interaction badge.

In accordance with certain aspects of the invention, the method further involves: receiving, on the RFID transceiver of the reconfigurable interaction badge, an inquiry by a RFID reader and transmitting, in response to the inquiry, identification data. In some further aspects, the method also includes logging the inquiry and storing the log in the memory of the reconfigurable interaction badge. In still further aspects, the method includes outputting the log from the reconfigurable interaction badge. In certain such aspects, the outputting can be performed using a data port the reconfigurable interaction badge. In other aspects, the outputting is performed using the short-range wireless transceiver of the reconfigurable interaction badge.

In accordance with certain aspects of the invention, the method further involves: sending, via the RFID transceiver of the reconfigurable interaction badge, an inquiry for identification information; receiving, in response to the inquiry, identification information; and storing, in the memory of the reconfigurable interaction badge, the received identification information. In still further aspects, the method includes outputting the stored received identification information from the reconfigurable interaction badge. In certain such aspects, the outputting can be performed using a data port the reconfigurable interaction badge. In other aspects, the outputting is performed using the short-range wireless transceiver of the reconfigurable interaction badge. In still other aspects, the outputting can be performed using RFID (or NFC).

In accordance with certain aspects of the invention, the method further involves: receiving speech on the microphone; and outputting text on the display. In some certain aspects, outputting text involves: transmitting audio information received from the microphone using the short-range wireless transceiver or RFID (or NFC) to an external connected device for processing and conversion; receiving text from the external connected device using the short-range wireless transceiver or RFID (or NFC); and outputting the data or information as the text conversion on the display. In accordance with further aspects, the text conversion received from the external connected device comprises text that is a closed-captioned text conversion of the audio information. In accordance with other aspects, the text conversion received from the external connected device comprises text that is a language translation text conversion of the audio information from a first language of the audio information to a second language different from the first language for the text conversion.

### BRIEF DESCRIPTION OF THE FIGURES

These and other characteristics of the present invention will be more fully understood by reference to the following detailed description in conjunction with the attached drawings, in which:

FIG. 1 is a block diagram depicting an example environment in which a reconfigurable interaction badge of the present invention operates in accordance with certain embodiments;

FIG. 2 is a block diagram depicting a generic computing device that serves as a basis for a reconfigurable interaction badge or external connected device in accordance with certain aspects of the present invention;

FIGS. 3A, 3B, 3C, 3D are different views depicting a hardware configuration of a reconfigurable interaction badge in accordance with certain embodiments;

FIG. 4 is a is a flow diagram depicting a methodology for using a reconfigurable interaction badge;

FIG. 5 is a is a flow diagram depicting a methodology for performing passive radio frequency identification (RFID) using a reconfigurable interaction badge;

FIG. 6 is a is a flow diagram depicting a methodology for performing radio frequency identification (RFID) using a reconfigurable interaction badge;

FIG. 7 is a is a flow diagram depicting a methodology for performing speech-to-text processing using a reconfigurable interaction badge;

FIG. 8 is a is a flow diagram depicting a methodology for performing speech-to-text processing using an external electronic device connected to the reconfigurable interaction badge;

FIG. 9 is a screen shot showing speech-to-text translation using the reconfigurable interaction badge;

FIG. 10 depicts a front view of a reconfigurable interaction badge in accordance with an embodiment of the invention;

FIG. 11 depicts a back view of the reconfigurable interaction badge in accordance with an embodiment of the invention with the back cover of the body removed showing the other hardware of badge;

FIG. 12 depicts a back view of the reconfigurable interaction badge in accordance with an embodiment of the invention;

FIG. 13 is top left perspective view of the reconfigurable interaction badge in accordance with an embodiment of the invention;

FIG. 14 is top side view of the reconfigurable interaction badge in accordance with an embodiment of the invention;

FIG. 15 is bottom right perspective view of the reconfigurable interaction badge in accordance with an embodiment of the invention;

FIG. 16 is right side view of the reconfigurable interaction badge in accordance with an embodiment of the invention;

FIG. 17 in exemplary display of the speech-to-text functionality of the reconfigurable interaction badge in accordance with an embodiment of the invention; and

FIG. 18A and FIG. 18B show alternate ways of displaying the speech-to text functionality of the reconfigurable interaction badge in accordance with another embodiment of the invention.

### DETAILED DESCRIPTION

An illustrative embodiment of the present invention relates to a reconfigurable interaction badge. The interaction badge provided can be reconfigured as necessary to display or otherwise provide identification information or credentials for a specific application. The interaction badge can also provide control or access to when and where the information provided by the badge is accessed. Additionally, the interaction badge can provide additional functionality for a wearer such as location and interaction tracking, audio recording, speech-to-text, and language translation.

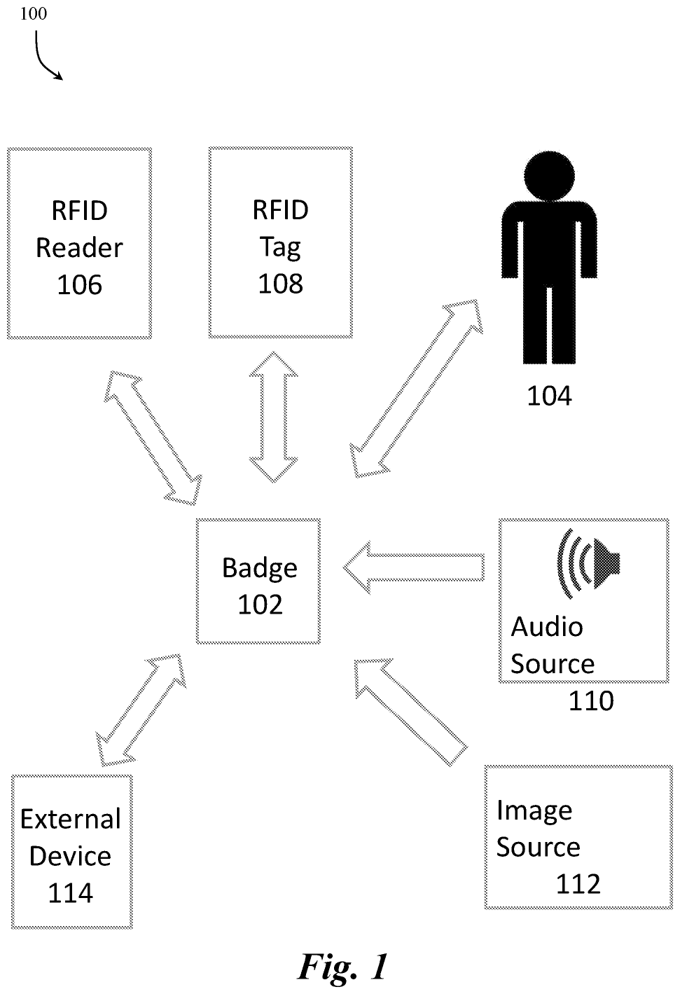

FIG. 1 through FIG. 18B wherein like parts are designated by like reference numerals throughout, illustrate an example embodiment or embodiments of a reconfigurable interaction badge according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts an example environment 100 in which a reconfigurable interaction badge 102 operates and interacts with other components or people. The environment 100 could be a workplace, hospital, trade show, convention or other environment 100 that identification badges are employed. In such environments 100 the badge 102, as well as the wearer of the badge, interact with other individuals 104 such as customers, patients, employees, or attendees. The environment is typically also provided radio frequency identification (RFID) devices such as readers 106 and tags 108 for tracking assets (including badge 102) within the environment 100. In certain embodiments, there may also be audio sources 110 and image sources 112 provided at the environment 100 that can provide information for use by the badge 102.

The individuals 104 in the environment 100 are the people with whom the wearer of the badge 102 would typically interact. These individuals 104 receive information visually from the information displayed on the badge 102. The individual 104 may also provide information to the badge 102 audibly and visually making use of the input hardware provided on the badge 102. In certain instances, the individual 104 is provided hardware such as another badge 102, RFID reader 106 or RFID tag 108 that is capable of transmitting or receiving information electronically with the badge 102.

In many of the environments 100 identification badges are traditionally employed, radio frequency identification (RFID) devices are also used. Readers 106 are placed at entrances, exits, security checkpoints, and other locations throughout the environment. Tags 108 are placed or otherwise attached to the assets or people to be tracked within the environment 100. The reader 106 electronically detects and interrogates the tag 108 (or badge 102) to identify the person or object the tag 108 (or badge 102) is associated with. This information can then be used to establish location or grant access for a person or object identified. In certain embodiments, the reconfigurable interaction badge 102 of the present invention can not only operate as a tag 108 but is further capable of detecting and interrogating tags 108 (or other interaction badges 102) like a reader 106. In still other embodiments, the RFID technology can be used to conduct financial transactions, such as payments, using the badge 102.

In certain embodiments, the environment 100 is provided with additional sources capable of delivering data audibly or visually to the badge 102 separate from the individuals 104. Audio sources 110 include speakers or public announcement systems that are provided or otherwise present in the environment 100. Audio information provided by such an audio source 110 is received by a microphone on the badge 102. Image sources 112 include displays, posters, stickers, labels, or the like that convey information visually. In certain embodiments, this visual information can include bar codes or quick response (QR) codes provided at locations or on assets or persons. In still other embodiments, image sources can include objects of individuals that can be identified with the use of object or facial recognition software.

To configure a reconfigurable interaction badge 102 for a particular environment 100, the badge 102 is connected to an external electronic device 114. The connection between the badge 102 and the external device 114 can be physical, such as through data cable connected to data ports of the badge 102 or external device 114; wireless, such as through Bluetooth® wireless protocol; RFID (such as Near Field Communication (NFC)), or any combination thereof. Other suitable connections will be apparent to those of skill in the art given the benefit of this disclosure.

The external electronic device 114 can be any type of suitable personal electronic device capable of being configured to perform the functionality of the present invention. The electronic device 114 is merely an illustrative example of a suitable computing environment and in no way limits the scope of the present invention. An “electronic device,” as represented by FIG. 1, can include a “workstation,” a “server,” a “laptop,” a “desktop,” a “hand-held device,” a “mobile device,” a “tablet computer,” or other computing devices, as would be understood by those of skill in the art. Given that the electronic device 114 is depicted for illustrative purposes, embodiments of the present invention may utilize any number of electronic devices 114 in any number of different ways to implement a single embodiment of the present invention. Accordingly, embodiments of the present invention are not limited to a single electronic device 114, as would be appreciated by one with skill in the art, nor are they limited to a single type of implementation or configuration of the example electronic device 114.

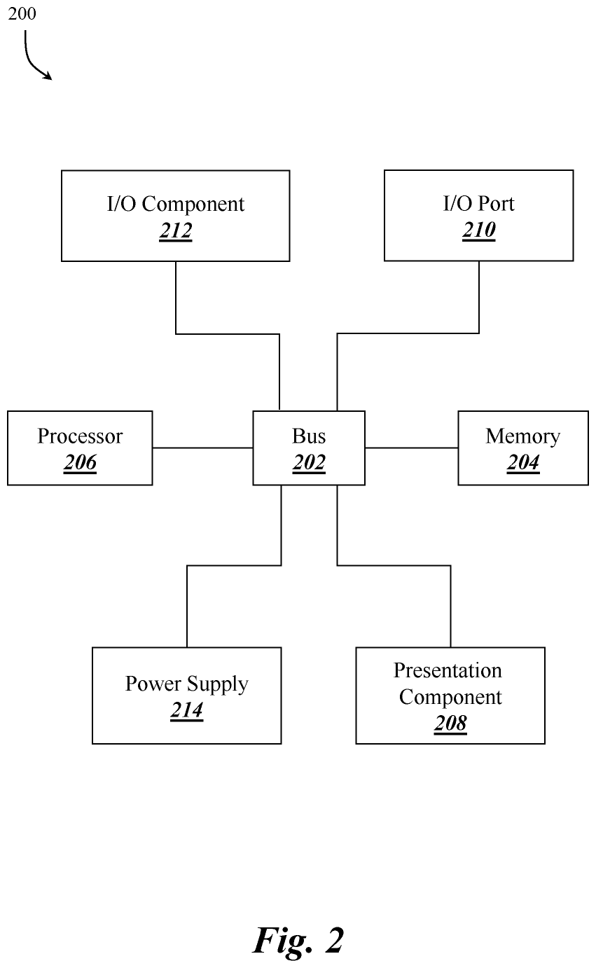

FIG. 2 depicts a high-level schematic of the hardware provided in an electronic device 200 that serves as the basic platform for the reconfigurable interaction badge 102 or external electronic device 114. The base electronic device 200 is merely an illustrative example of a suitable computing environment and in no way limits the scope of the present invention. The base hardware depicted and described herein can be configured, modified, or adapted as necessary to provide the desired functionality set forth herein.

The electronics device 200 that the badge 102 or external electronic device 114 are based or otherwise built upon can include a bus 202 that can be coupled to one or more of the following illustrative components, directly or indirectly: a memory store 204, one or more processors 206, one or more presentation components 208, input/output ports 210, input/output components 212, and a power supply 214.

One of skill in the art will appreciate that the bus 202 can include one or more busses, such as an address bus, a data bus, or any combination thereof. One of skill in the art additionally will appreciate that, depending on the intended applications and uses of a particular embodiment, multiple of these components can be implemented by a single device. As such, FIG. 2 is merely illustrative of an exemplary generic computing device that can be used to implement one or more embodiments of the present invention, and in no way limits the invention.

The computing device 200 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 200.

The memory store 204 can include computer-storage media in the form of volatile and/or nonvolatile memory. The memory store 204 may be removable, non-removable, or any combination thereof. Exemplary hardware devices are devices such as hard drives, solid-state memory, optical-disc drives, and the like. The computing device 200 can include one or more processors 206 that read data from components such as the memory store 204, the various I/O components 212, etc. Presentation component(s) 208 present data indications to a user or other device. Exemplary presentation components include a display device, speaker, printing component, vibrating mechanism component, etc.

The I/O ports 208 can enable the computing device 200 to be logically coupled to other devices, such as I/O components 212. Some of the I/O components 212 can be built into the computing device 200. Examples of such I/O components 220 include a microphone, camera, joystick, recording device, game pad, satellite dish, scanner, printer, radio frequency identification (RFID) device, wireless device, networking device, and the like.

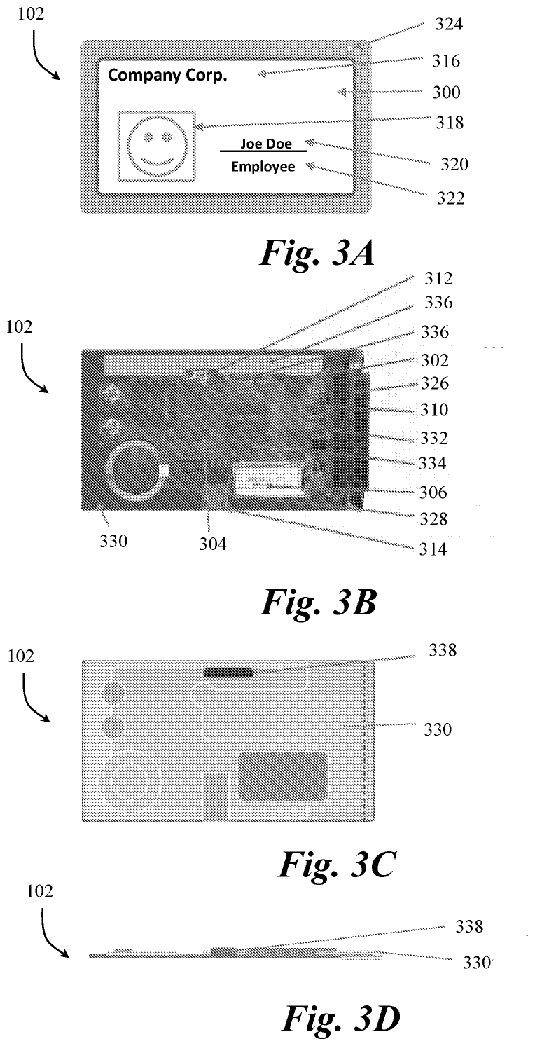

FIGS. 3A-3D depict various view of a specific configuration of hardware for a reconfigurable interaction badge 102 based on the electronic device 200 of FIG. 2 in accordance with an embodiment of the present invention. FIG. 3A depicts a front view of the badge 102 showing the display 300. FIG. 3B depicts a front view of the badge 102 with the display 300 removed showing the other hardware of the badge 102. FIG. 3C depicts a back view of the badge 102. FIG. 3D depicts an edge view of the badge 102 with the display removed.

In this specific hardware configuration, the components of the reconfigurable interaction badge 102 are chosen to provide low power consumption allowing for all day usage while keeping the size and weight of the badge 102 such that it is comfortable to be worn from a lanyard around the user's neck or fastened/attached to clothing via mechanical, pin, or magnet. These components include a display 300, a processor 302, a memory store 304, a power store 306, a radio frequency identification (RFID) transceiver 308, a short-range wireless transceiver 310, a microphone 312, and a data port 314. In accordance with some embodiments, the interaction badge 102 weighs approximately 1.5 ounces. In other embodiments, the badge 102 is sized and configured for table or countertop use allowing for a larger display 300 and greater weight.

The display 300, as seen in FIG. 3A, is for displaying data about a user on the reconfigurable interaction badge 102. This data typically includes information found on an identification badge such as: a company affiliation 316, a photo 318, a name 320, and a title or position 322. As this information needs to be displayed on a consistent basis, the display 300 is preferably of a type that is low power, allowing for long operating time without requiring a large power store 306. In some embodiments, the display 300 is touch-sensitive such that a user can provide input by touching the display 300. In some such embodiments, the screen can receive inputs from a stylus or finger, allowing the badge to act as a virtual notepad. In certain embodiments, the display 300 comprises an electronic-paper (e-paper) display. E-paper is a thin, lightweight, monochrome or color display that is daylight readable. Its appearance and how it displays information is not unlike paper. It has low power modes to save battery life. In some cases it can continue to display the screen image while consuming no power from the power source (battery). In certain embodiments, the e-paper has a refresh rate of between once every second and ten (10) times a second. The e-paper display, as utilized herein, refers to electronic ink displays, electrophoretic displays, and electronic paper displays, which are display technologies that mimic the appearance of ordinary ink on paper as would be appreciated by those of skill in the art. Other suitable or possible display types or technologies will be apparent to on skilled in the art given the benefit of this disclosure.

In certain embodiments, the screen may further be provided with a camera 324. The camera 324 is in electronic communication with the processor 302 and configured to receive image information. In some embodiments, the camera 324 is capable of capturing still or video image information. The image information may be from individuals 104 or from other image sources 112 such as displays. In some embodiments, the image information received by the camera 324 can be recorded and stored in the memory store 304. In this way a visual record of who and what the user interacted with is created. In other embodiments, the image information received by the camera 324 is processed. This processing can be performed by the processor 302 or an external device 114 in communication with the badge 102. In some such embodiments, bar codes or QC codes can be scanned using the camera 324. In some such embodiments, the image information can act as way to visually identify an object, person, or event, including the use of object or facial recognition software. In still other embodiments the image information can act as a cue or trigger that activates additional functionality or actions.

The processor 302, as seen in FIG. 3B, is in electronic communication with the display 300 via the display connection 326 such that the display 300 can be removed to replace the display 300 or gain access to the other components of the badge 102. The processor 302 is configured to provide data for output on the display 300. The processor 302 can also provide the some or all of the processing and/or functionality for the RFID transceiver 308, the short-range wireless transceiver 310, the microphone 312, and the data port 314. In certain embodiments, the processor 302 is configured to provide processing for additional hardware. For example, in embodiments with a camera 324, the processor 302 can provide processing for camera 324 as well. In some embodiments, the processor 302 creates a record for each use of the connected hardware. In certain embodiments, the processor 302 is configured to provide processing for additional functionality such as text-to-speech or translation. The processor 302 is preferably of a size and configuration to provide suitable functionality while keeping the power consumption and weight to a minimum.

In certain embodiments, the processor 302 is configured to provide processing for additional functionality. For example, in some such embodiments, the processor 302 is further configured to receive audio information such as speech via microphone 312 and output text on the display 300. The speech to text functionality may be provided by the processor 302 or be handled externally from the badge 102. In some embodiments this involves transmitting audio information received from the microphone 312 to an external connected device 114 for conversion using the short-range wireless transceiver 310 or RFID functionality (such as NFC), receiving text from the external connected device 114 using the short-range wireless transceiver 310 or RFID functionality (such as NFC), and outputting the text on the display 300. In some such embodiments, the text received from the external connected device 114 comprises text that is a closed-captioned text conversion of the audio information. In still other such embodiments, the text received from the external connected device 114 comprises text that is a language translation text conversion of the audio information.

Similarly, the processor 302 can be further configured to process image data, such as from the camera 324. Such image processing may be provided by the processor 302 or be handled externally from the badge 102. In some embodiments this involves transmitting image information received from the camera 324 to an external connected device 114 for analysis using the short-range wireless transceiver 310 or RFID functionality (such as NFC), The identification can then be stored on the connected external device 114 or transmitted to the badge 102 from the external connected device 114 using the short-range wireless transceiver 310 or RFID functionality (such as NFC), where the identification can be stored and/or outputted on the display 300.

In some embodiments, the processor 302 is configured to provide a virtual assistant that can perform tasks in response to audio or visual inputs from the microphone 312 or camera 324. The functionality of the virtual assistant can be provided by the processor 302 of be handled external from the badge 102. In some embodiments this involves transmitting audio or image information received from the microphone 312 or camera 324 to an external connected device 114 for processing using the short-range wireless transceiver 310 or RFID functionality (such as NFC).

The memory store 304 is in in electronic communication with the processor 302. The memory store 304 is configured to hold instructions and data for execution by the processor 302. The memory store 304 is preferably of a size and configuration to provide suitable functionality while keeping the power consumption and weight to a minimum.

The power store 306 powers the processor 302 and display 300. The power store 306 can also provide power to the memory store 304, the RFID transceiver 308, the short-range wireless transceiver 310, the microphone 312, and the data port 314. In some embodiments, the power store 306 is configured to provide power for additional hardware. In the embodiment of FIGS. 3A-3D, the power store is a battery. In certain embodiments, the battery is a rechargeable battery. In some such embodiments, the battery is charged through the data port 314. In other such embodiments, the battery is charged using inductive or wireless power such a provided by radio frequency received on inductor coil 328. Other suitable power sources and charging methodologies will be apparent to one skilled in the art given the benefit of this disclosure.

The radio frequency identification (RFID) transceiver 308 can includes a RFID chip in electronic communication with the processor 302 (or the functionality may be incorporated into the processor 302) and is configured to transmit data. In some embodiments, the data includes identification data that comprises a unique number, letter, or number-letter combination that is assigned to the badge 102 or processor 302. In some cases, this identification data is assigned at creation of the badge, is unique, and cannot be changed. In some embodiments, the user is provided the ability to control the operation of the RFID transceiver 308. In some such embodiments, the RFID transceiver 308 operates in a passive manner acting as a RFID tag that only transmits data when energized by a RFID reader 106. In other embodiments, the RFID transceiver 308 operates in an active manner and can transmit data or even interrogate other RFID tags 108. In certain embodiments, the RFID transceiver 308 is capable of communicating using Near Field Communication (NFC). In some such embodiments, the RFID transceiver is capable of performing transactions, such as making or receiving payments. In some embodiments, the processor 302 may create and store a log of each use of the RFID transceiver 308 in the badge 102. This log can then be outputted to an external device 114 for analysis and review. The log provides the user a record of when and how the RFID functionality of the badge 102 was used. This information can be used to determine what or who the user interacted with. This information can in turn be used to identify the location of the badge, as well as the badge wearer. In certain other embodiments, the activation of the RFID functionality can act as a trigger for the activation of other functionality. For example, the interrogation of the badge 102 might trigger the microphone 312 or camera 324 to activate thus creating an audio or image record to be included with the log.

The short-range wireless transceiver 310 is in electronic communication with the processor 302 and configured to transmit and receive data. The short-range wireless transceiver 310 can be used to connect the badge with the external electronic device 114 for configuration of the badge 102 or transfer or data for external analysis and processing. The short-range wireless transceiver 310 is preferably of a size and configuration to provide suitable functionality while keeping the power consumption and weight to a minimum. In the embodiment of FIGS. 3A-3D, the short-range wireless transceiver 310 is a Bluetooth® capable transceiver. Other suitable protocols or transceiver configurations will be apparent to one skilled in the art given the benefit of this disclosure.

The microphone 312 is in electronic communication with the processor 302 and configured to receive audio signals. The audio signals may be from individuals 104 or from other audio sources 110 such as speakers. In some embodiments, the audio signals received by the microphone 312 can be recorded and stored in the memory store 304. In this manner the badge 102 can act as a personal digital recorder for recording notes or other sounds. In other embodiments, the audio signal received by the microphone 312 is processed. This processing can be performed by the processor 302 or an external device 114 in communication with the badge 102. In some such embodiments, the text-to-speech or translation processing can be performed on the audio information. In other embodiments, the sound can act as an audio identification or fingerprint that identifies an object, person, or event. In still other embodiments the sound can act as an audio cue or trigger that activates additional functionality or actions. In other embodiments, audio signals can be transmitted to other devices, including other interaction badges 102. In such cases, the receiving badge 102 can then perform speech to text on the received audio.

The microphone 312 can be included in the body of the badge 102 or be separate. In certain embodiments, the badge 102 can make use of multiple microphones 312. For example, microphones 312 can be placed at different locations to provide indication as to the source of the audio. For example, audio detected by a microphone in proximity of the badge wearer's head and targeted to receive the user's voice can be an indication that the wearer is the one providing the audio, while audio detected by a microphone located away from the badge wearer's head and targeted outward from the badge toward a third party indicates that another source is responsible for the audio. In such embodiments, the badge 102 can provide speech-to-text conversion or translation while also indicating the source of the text. Similarly, the behavior, performance, or processing of the badge 102 can change or be different based on which microphone detects the audio. For example, only the microphone in proximity to the badge wearer's head may activate virtual assistant functionality.

The data port 314 is in electronic communication with the processor 302 and configured to transfer data to and from the processor 302. In certain embodiments, the data port 314 is further configured to transfer power to and from the power store 306 of the badge 102. The data port 314 is preferably of a size and configuration to provide suitable functionality while keeping the power consumption and weight to a minimum. In the embodiment of FIGS. 3A-3D the data port is a Universal Serial Bus (USB) port. Other suitable protocols or data port configurations will be apparent to one skilled in the art given the benefit of this disclosure.

In the embodiment of FIGS. 3A-3D the reconfigurable interaction badge 102 includes additional hardware. This additional hardware includes a body 330, a power switch 332, a function switch 334, an attachment strip 336, and a lanyard loop 338. In some such embodiments, the badge may also include vibration functionality to provide notifications to the user.

The body 330 holds the components of the reconfigurable interaction badge 102. The body 330 is sized and dimensioned to hold all the components while still being of a size to function as an identification badge. As such, the body 330 is generally rectangular in shape and having a thickness sufficient to support the components while not being cumbersome to wear, such as on a lanyard around the user's neck. The body 330 is preferably formed of a strong and lightweight material. The body 33 can be formed of a conductive material, a non-conductive material, or a combination of both. In certain embodiments the body 330 is formed of plastic. In some such embodiments, the body 330 also incorporates or otherwise serves as a Printed Circuit Board (PCB) providing the electronic interconnection between the components. In other embodiments, the body is sized and configured for use on a table or counter top.

The power switch 332 serves to power on or power off the reconfigurable interaction badge 102. In certain embodiments, the power switch 332 can activate additional functionality, such as low power, or test mode. The function switch 334 serves to activate different functionality of the badge 102. For example, the function switch 334 can activate or deactivate the RFID functionality of the badge 102, including the whether the badge is operating in passive or active RFID mode. Likewise, the function switch 334 could activate or deactivate the microphone functionality of the badge 102 including the recording or speech-to-text functionality. Other suitable actions or functionality for either the power switch 332 or function switch 334 will be apparent to one skilled in the art given the benefit of this disclosure.

The attachment strip 336 is a strip of metal that allow for magnetic attachment to the body 330 of the reconfigurable interaction badge 102. For example, in some embodiments, the display 300 may be attached magnetically. Likewise, the attachment strip 336 can be used to attach the badge to other items. For example, the badge 102 may magnetically adhere to a charging pad during wireless or inductive charging.

The lanyard loop 338 is attached to the back side of body 330 of the badge 102 as seen in FIG. 3C and FIG. 3D. The lanyard loop 338 is located generally toward the top edge of the badge 102 and is sized and configured to receive a lanyard through the loop 338 allowing the badge to be worn around a user's neck by the lanyard.

In certain embodiments, the badge 102 can be provided with a GPS receiver. The GPS receiver can be part of the hardware on the badge 102 or provided on an external electronic device 114. In some embodiment, the location information provided by the GPS can be displayed on the display 300 of the badge 102. For example, a floorplan or other map can be provided with an indicator of the badge's position on the floorplan. In other embodiments the GPS functionality is triggered by other functionality of the badge 102, such as RFID 308, the microphone 312, or the camera 324 to create a location record to go along with the activity log.

In certain embodiments, the badge 102 can include functionality allowing it to participate as part of a mesh network. As used herein, s mesh network is a group of interconnected devices connected via radio transceivers or other wireless technologies. Data can originate from any device and can be sent to any or all devices in the mesh network. Each device in the mesh network is capable of relaying the data. So with many devices spread over a wide area, any data can be relayed over that wide area. This can be many times the range of a single device. In some such embodiments, one or more devices connected to the mesh network, such as an external device 114, can be configured to record any or all information on the network. One benefit of such mesh networks is that a relative location can be derived from the signals going between the devices on the mesh network. If there are devices of known location (beacons), the mesh network can then take those relative locations to determine real locations. In some embodiments, there is an option of setting up a number of known location mesh devices in beacon mode, that broadcast their location. So any other device can take the known locations of the configured beacons to determine location of the device. In such a network, each device can share it's real location with the rest of the network.

While devices are in a mesh network, the devices can report any information in real time. This can be used to do many useful things. For Example: In a hospital; if a nurse with a particular skill is needed in a patient room, a search of devices (badges 102) for nurse & skill & location. Then page that nurse by causing the badge 102 to vibrate, flash or beep (or any combination). If the nurse pushes a function button on the badge 102, it will give her instructions. In a convention center; determinations regarding how many attendees are in the center, how many are in each presentation, etc. can be made. This information can include the name or other information for each person. With a mesh beacon at a convention booth, it can be determined who visited the booth and how long did they stay. Alternately, it can record just the amount of people who visited the booth, and time durations of the visits. The mesh network can also be used to keep track of how many people are in each room to ensure maximum occupancy limits are not exceeded.

In still other embodiments, the devices in the mesh network can keep track of the identification data of each badge that was within a particular distance from each other, and when they were close. This can be used for contact tracing for contagions.

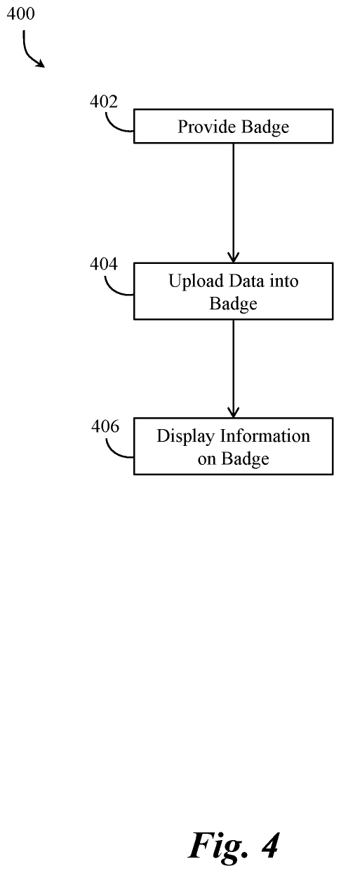

The functionality of the present invention is provided by the system and hardware of FIGS. 1-3 through the execution of software that makes the hardware perform in the desired manner. FIG. 4 depicts a flow diagram 400 of one possible implementation of processes for operating the reconfigurable interaction badge 102 in accordance with aspects of the present invention.

The first step of the methodology of the flow diagram 400 of FIG. 4 is providing the reconfigurable interaction badge 102 as describe above in reference to FIGS. 1-3 (step 402). The next step is uploading data into the memory store 304 for execution by the processor 302 to display identification information on the display 300 (step 404). The last step in basic operation of the badge 102 is displaying the identification information on the display 300 (step 406).

The uploading of data (step 404) can be performed using the data port 314, or the short-range wireless transceiver 310, or RFID functionality (such as NFC). In certain embodiments, the badge 102 is connected to an external electronic device 114 using a data cable or wireless connection. The external device 114 is provided with an application that allows the user to input and otherwise configure what information data is displayed and how it is displayed on the display 300 of the badge 102. For example, the badge 102 typically displays: company 316, photo 318, name 320 and title/position 322 information as seen and discussed in relation to FIG. 3A. This information and how to display it is what is uploaded to the badge in step 404. The resulting display as seen in FIG. 3A is what provided in step 406.

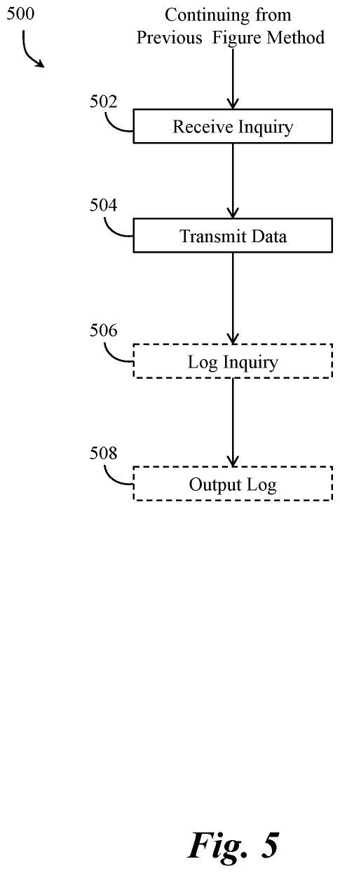

As discussed previously in this disclosure, the badge is capable of providing additional functionality as well as the display of identification information. On type of such functionality is Radio Frequency Identification (RFID). In certain embodiments, the RFID transceiver 308 of the badge 102 operates in a passive mode. An example of the methodology for such operation in accordance with an embodiment of the invention can be seen in FIG. 5.

The first step of the methodology of the flow diagram 500 of FIG. 5 is receiving, on the RFID transceiver 308, an inquiry by a RFID reader 106 (step 502). The transceiver 308 then transmits identification data in response to the inquiry (step 504). In certain embodiments, the processor 302 is configured to generate and store a log of the inquiry and store it in the memory store 304 (step 506). This log may then be outputted from the badge 102 (step 508).

The outputting of the log (step 508) can be performed using the data port 314 or the short-range wireless transceiver 310 or RFID functionality (such as NFC). In certain embodiments, the badge 102 is connected to an external electronic device 114 using the data cable or wireless connection. The external device 114 is provided with an application that allows a user, company, or management or security personnel to receive, analyze, and process the information contained in the log. In certain embodiments, the log may further contain additional data including audio, image, or location data provided by other functionality or hardware of the badge 102.

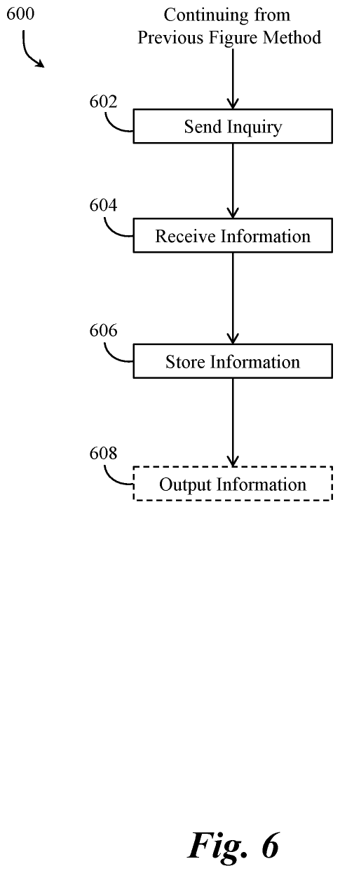

While FIG. 5 provided a methodology for the passive operation of the RFID, FIG. 6 depicts a flowchart 600 of a methodology for active RFID operation.

The first step of the methodology of the flow diagram 600 of FIG. 6 is sending, via the RFID transceiver 308, an inquiry for identification information (step 602). The transceiver 308 then receives the identification data in response to the inquiry (step 604). The processor 302 is configured to store the received identification information in the memory store 304 (step 606). In certain embodiments, this identification information may then be outputted from the badge 102 (step 608)

The outputting of identification information (step 508) can be performed using the data port 314 or the short-range wireless transceiver 310. In certain embodiments, the badge 102 is connected to an external electronic device 114 using a data cable or wireless connection. The external device 114 is provided with an application that allows the user to receive, analyze, and process the identification information. In certain embodiments, additional data including audio, image, or location data provided by other functionality or hardware of the badge can be outputted with the identification information.

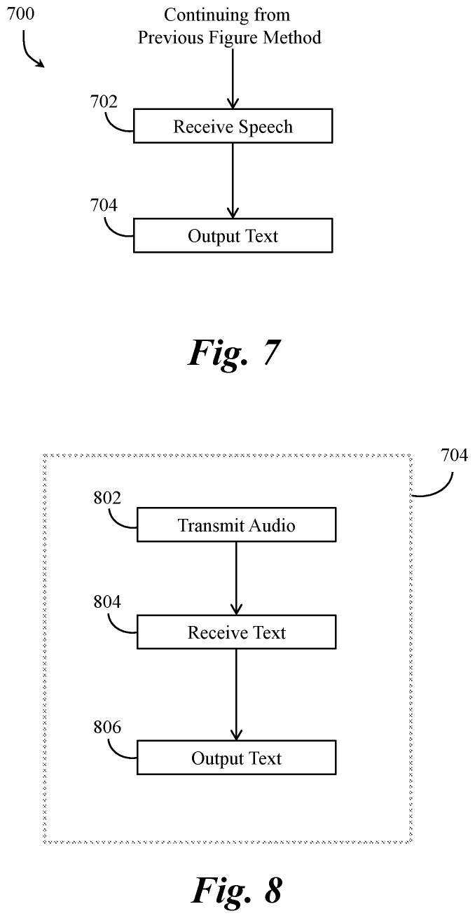

In certain embodiments, the reconfigurable interaction badge 102 is further configured with the ability to provide speech-to text functionality. An example of high-level methodology for such functionality in accordance with an embodiment of the invention can be seen in FIG. 7.

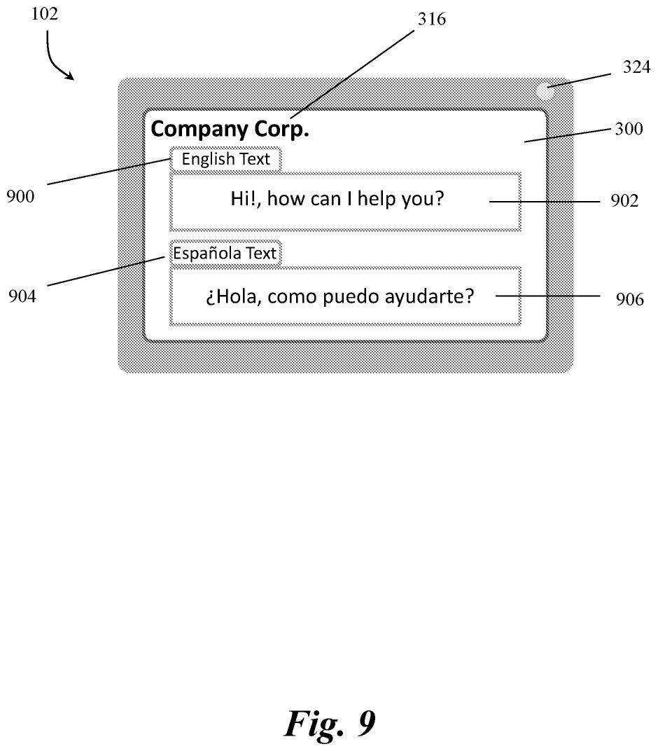

The first step of the methodology of the flow diagram 700 of FIG. 7 receiving audio information on the microphone 312 of the interaction badge (step 702). Text is then outputted on the display 300 (step 704). In certain embodiments, the text is closed caption text conversion of the received audio information. In other embodiments, the text is a language translation text conversion of the audio information from a first language of the audio information to a second language different from the first language for the text conversion. The processing of the audio information to generate the text can be performed on the badge 102 by the processor 302 or performed externally. FIG. 8 depicts a flowchart representing the additional steps that go into outputting the text on display 300 (step 704) in FIG. 7 when and external electronic device 114 is used for the processing.

The first step of the FIG. 8 is transmitting audio information received from the microphone 312 to an external device 114 for conversion using the short-range wireless transceiver 310 or RFID functionality (such as NFC), of the badge 102 (step 802). The next step is receiving text from the external device 114 using the short-range wireless transceiver 310 or RFID functionality (such as NFC), (step 804). In some such embodiments, the text is provided as screen image in binary pixel data. Lastly, the received text is outputted on the display 300.

The external device 114 connected to the badge 102 can be provided with an application capable of receiving audible information and generating text from the audio information. This generated text can be closed caption text of the audio information or a text language translation of the audio information from a first language to a second language or both. In some embodiments, the external electronic device 114 may make use of external speech-to-text or translation processing such as what is provided by web or cloud implemented services.

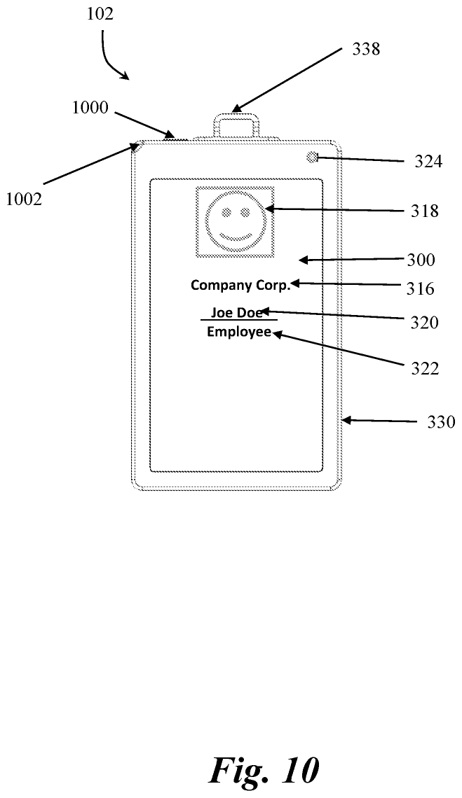

FIG. 9 depicts an example display of the reconfigurable interaction badge when the speech-to-text functionality of the badge 102 is activated. Here the display 300 has a first language indication field 900 and corresponding first text field 902. A second language indication field 904 and corresponding second text field 906 are also provided. In this example, the first language indication field 900 indicates the first selected language is English. The corresponding text field 902 shows the closed caption text for a spoken introduction “Hi! How may I help you?” The second language indication field 904 indicates the second selected language is Spanish. The corresponding text field 906 shows the translation of the introduction, in this case “% Hola, como puedo ayudarte?”.

In certain embodiments the first language and second language as indicated by the first language indication field 900 and the second language indication field 904 are selected by a user. In some such embodiments, the selection is selected using the function switch 334, the on/off switch 332 or some combination thereof. In other embodiments, the selection of language is made using an external connected device 114 connected to the badge 102. In still other embodiments, where the screen is touch enables, the languages can be selected by touching the display 300. For example, the desired language can be selected using a pull down menu. In still other embodiments, the language is automatically selected based on the audio information received.

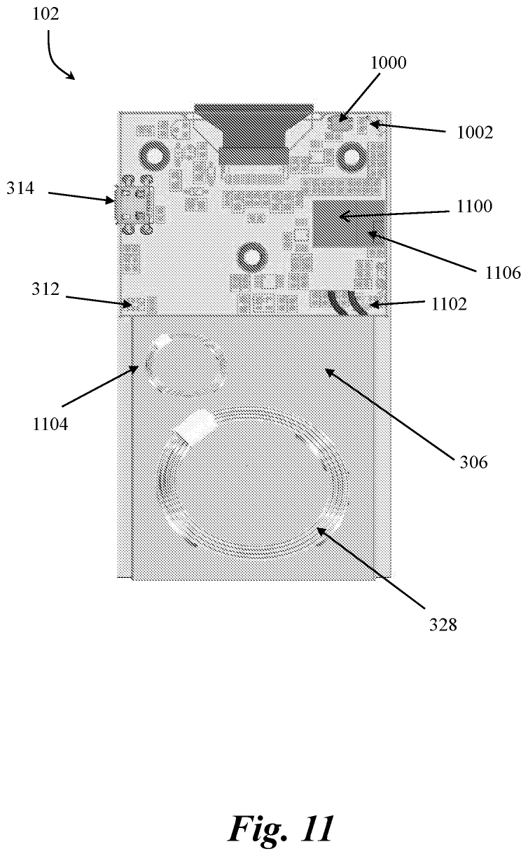

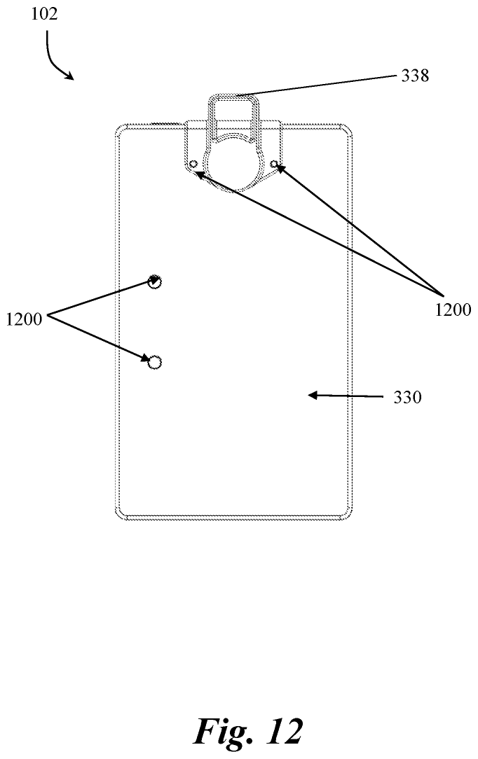

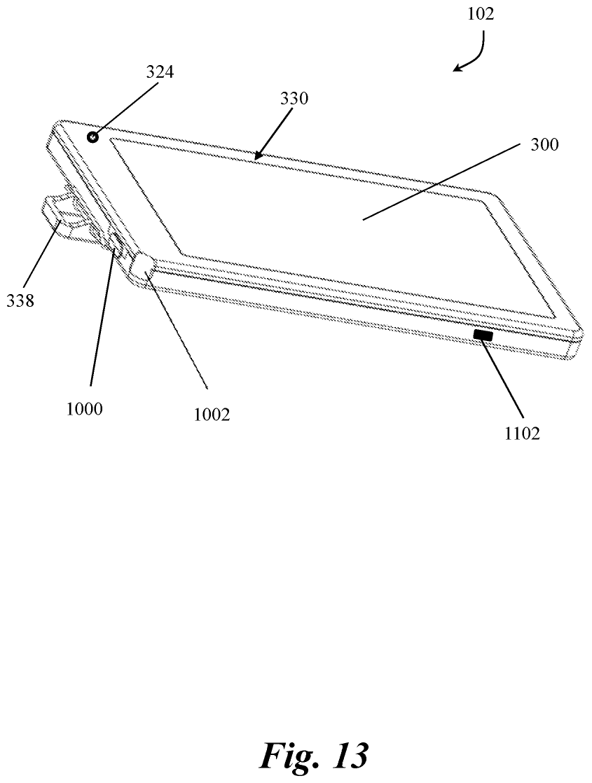

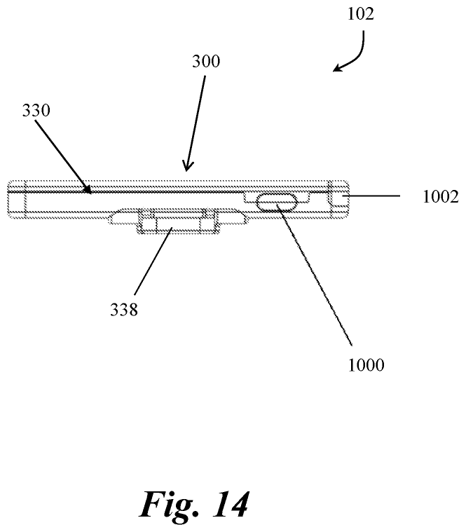

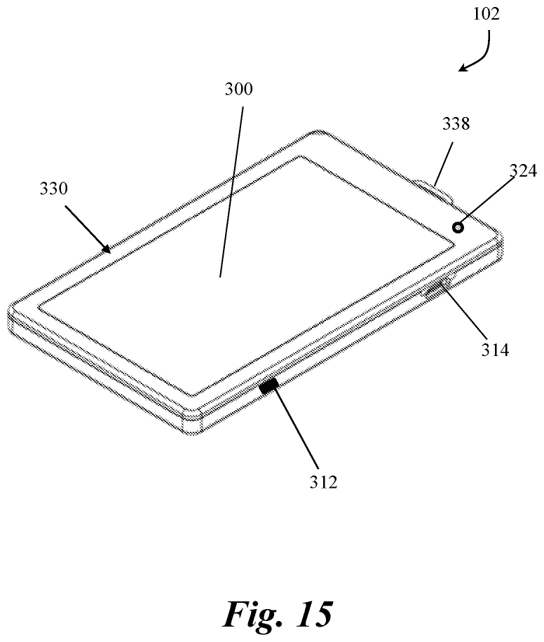

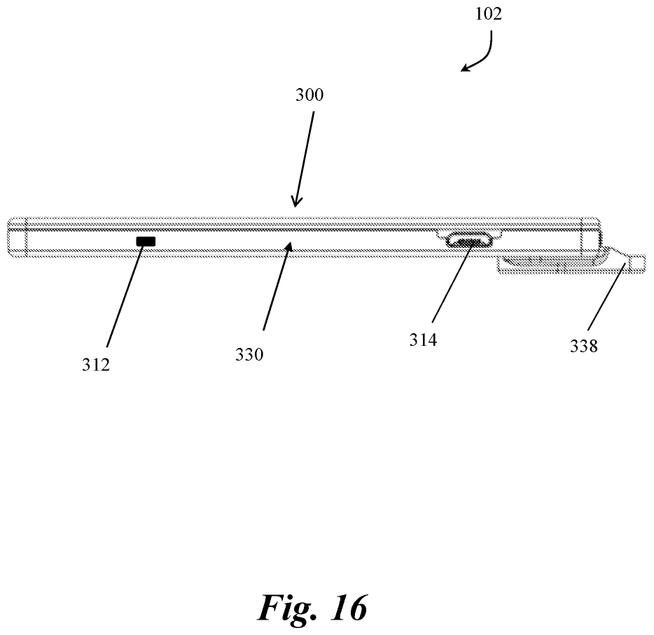

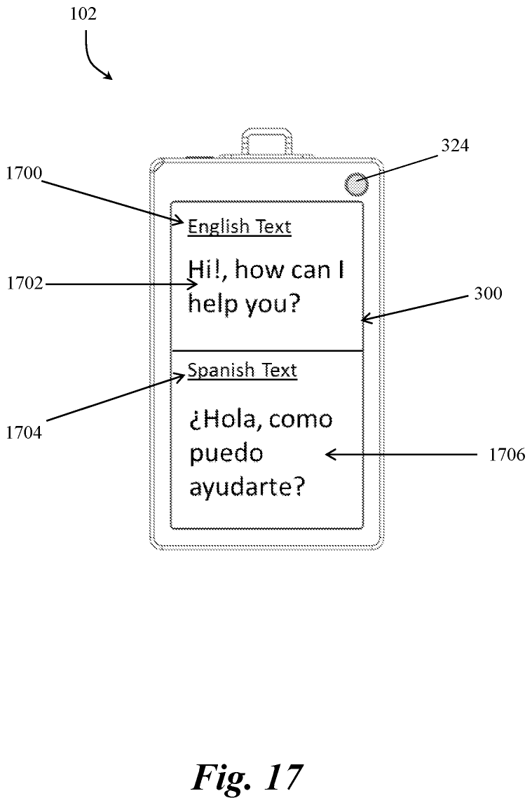

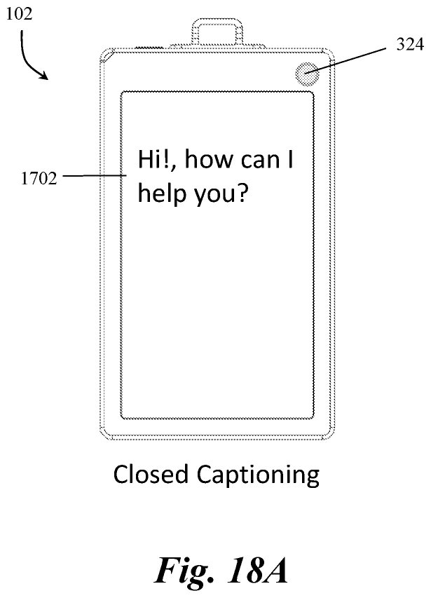

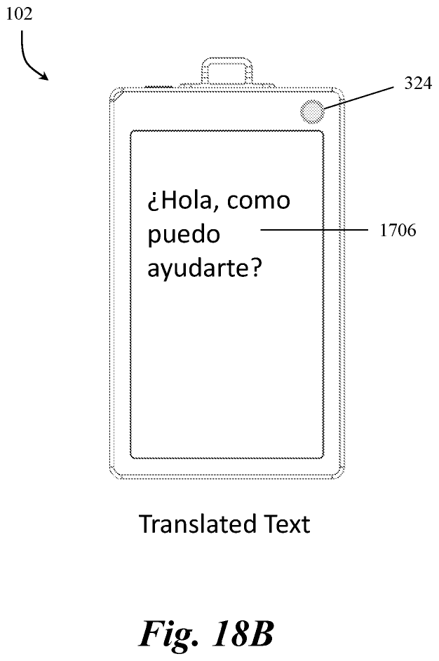

FIGS. 10-18B depict another embodiment of the interaction badge 102 and its functionality in accordance with an embodiment of the invention. FIGS. 10-16 depict various view of the specific configuration of hardware for another embodiment of a reconfigurable interaction badge 102 in accordance with an embodiment of the present invention. FIG. 10 depicts a front view of the badge 102 showing the display 300. FIG. 11 depicts a back view of the badge 102 with the back cover of the body removed showing the other hardware of the badge 102. FIG. 12 depicts a back view of the badge 102. FIG. 13 is top left perspective view of the badge 102. FIG. 14 is top side view of the badge 102. FIG. 15 is bottom right perspective view of the badge 102. FIG. 16 is right side view of the badge 102. FIG. 17 in exemplary display of the speech-to-text functionality of the badge 102. FIG. 18A and FIG. 18B show alternate ways of displaying the speech-to text functionality of the badge 102.

A front view of the badge 102 in FIG. 10 is similar to the front view of the previous embodiment of the badge 102 shown in FIG. 3A with the display 300 displaying information typically found on an identification badge such as: a company affiliation 316, a photo 318, a name 320, and a title or position 322. In this example, however, the badge 102 is in portrait orientation whereas the embodiment of FIG. 3A had a landscape orientation. It should be understood that the badge in any embodiment could have either a portrait or landscape orientation. In certain embodiments, the orientation of the display 300 could be adjusted when the information (company name 316, photo 318, name 320, title/position 322) of the display 300 is set-up or otherwise configured. In other embodiments, the badge 102 could include and orientation sensor that could change the display 300 of the badge as the orientation of the badge 102 changed. This embodiment also has a combination Power/Function switch 1000 and a indicator light 1002

FIG. 11 depict the internal components of the badge 102 in this embodiment of the invention. In addition to the power store 306, microphone 312, data port 314, and inductor coil 328 discussed in relation to the previous embodiment, this embodiment of the badge also includes an Power/Function switch 1000, Indicator Light 1002, System on Chip (SOC) processor 1100, a second microphone 1102, RFID coil/antenna 1104, and short-range wireless antenna 1106.

The Power/Function switch 1000 provides much of the same functionality of both the power switch 332 and function switch 334 previously discusses in regard to the previous embodiment. The functionality of the switch can change depending on the duration, or pattern of activation as well as current operating state of the badge 102.

The indicator light 1002 is provided by a LED light, in this case a three (3) color RGB LED, that is capable of virtually the full visible spectrum, that placed at a corner of the badge 102 The indicator light 1002 can flash or illuminate it in any number of colors and sequences desired to provide a variety of notifications or status indications. In certain embodiments, the indicator light 1002 is comprised of a light emitter disposed inside the interaction badge 102 optically coupled with a light transmission fiber coupled with a light box disposed at a corner of the interaction badge 102 enabling the indicator light 1002 to be viewable by the user and a third party. Placing the indicator light 1002 at the corner of the badge 102 allows it to be visible to both the person wearing the badge 102, and a person facing the wearer of the badge 102.

The SOC processor 1100 provides the functionality of the processor 302 as well as incorporating the some or all of the functionality of Radio Frequency Identification (RFID) transceiver 308 and short-range wireless transceiver 310 discussed in relation to the previous embodiment depicted in FIGS. 3-9. In certain embodiments, the SOC processor 1100 can include additional functionality, including, but not limited to, any of the functionality discussed in relation to the generic electronic device 200 of FIG. 2.

In the embodiment, a second microphone 1102 is provided that is located opposite of the first microphone 312 on the body 330. As previously discussed, having the second microphone 1102 placed at different location from the first microphone 312 can provide indication as to the source of the audio. For example, audio detected by a microphone 312, 1102 in proximity of and targeted to the badge wearer's head can be an indication that the wearer is the one providing the audio, while audio detected by a microphone 1102, 312 located away from the badge wearer's head and targeted outwardly from the badge indicates that another source is responsible for the audio, such as a third party talking to the badge wearer. In such embodiments, the badge 102 can provide speech-to-text conversion or translation while also indicating the source of the text. Similarly, the behavior, performance, or processing of the badge 102 can change or be different based on which microphone 312, 1102 detects the audio. For example, only the microphone 312, 1102 in proximity to the badge wearer's head may activate virtual assistant functionality.

The RFID/NFC coil 1104 and wireless antenna 1106 are the physical antenna that receive or transmit the data for the respective RFID (or NFC) or short-range wireless (Bluetooth) functionality provided by the Radio Frequency Identification (RFID) transceiver 308, short-range wireless transceiver 310, or SOC processor 1100. In some embodiments, the RFID/NFC coil 1104 and/or wireless antenna 1106 may be powered to improve reception or transmission performance.

In the embodiment shown in FIGS. 10-18B, the body 330 of the badge 102 serves to enclose and hold the display 300 as well as the other components of the badge 102. In the embodiment of FIGS. 10-18B, the lanyard loop 338 is attached to mounting features 1200 on the back side of the body 330 as shown in FIG. 12. In this embodiment, two sets of mounting features 1200 on two sides of the body 330 of the badge 102 allow the lanyard loop 338 to be moved based on the desired orientation of the badge 102. In certain embodiments, the mounting features 1200 may include a sensor or switch that indicated that the orientation display 300 should be switched depending on which way the lanyard loop 338 is attached.

In FIG. 13 and FIG. 14, the display 300, camera 324, lanyard loop 338 power/function switch 1000, indicator light 1002 and second microphone 1200 and their respective locations on the body 330 of the badge 102 of the present embodiment can be seen.

In FIG. 15 and FIG. 16, the display 300, microphone 314, data port 314, camera 324, lanyard loop 338, and their respective locations on the body 330 of the badge 102 of the present embodiment can be seen.

FIG. 17 depicts speech-to-text operation on the badge 102 of FIGS. 10-16 in accordance with one embodiment. Here, like in FIG. 9 the display 300 has a first language indication field 1700 and corresponding first text field 1702. A second language indication field 1704 and corresponding second text field 1706 are also provided. However, unlike in FIG. 9, in this embodiment, the information is provided in portrait orientation. The first language indication field 1700 indicates the first selected language is English. The corresponding text field 1702 shows the closed caption text for a spoken introduction “Hi! How may I help you?” The second language indication field 1704 indicates the second selected language is Spanish. The corresponding text field 1706 shows the translation of the introduction, in this case “¿Hola, como puedo ayudarte?”.

FIG. 18A and FIG. 18b depicts an example displays of the speech-to-text operation where the closed captioning 1702 and corresponding translation 1706 are provided on separate screens. In FIG. 18A, the closed captioning 1702 is displayed. In FIG. 18B, the translation to Spanish 1706 is displayed.

In view of the preceding discussion, the disclosed reconfigurable interaction badge of the present invention provides significant advantages over conventional identification badges. The interaction badge provided can be reconfigured as necessary to display or otherwise provide identification information or credentials for a specific application. The interaction badge can also provide control or access to when and where the information provided by the badge is accessed. Additionally, the interaction badge can provide additional functionality for a wearer such as location and interaction tracking, audio recording, and language translation. The hardware and components of the badge are chosen to provide the necessary functionality while providing all-day operation and being comfortable to wear by a user.

### Example Use Cases

Currently, medical personnel, government employees, corporate employees often wear badges. Replacing conventional badges with the reconfigurable interaction badge of the present invention adds functionality that makes the required badge much more useful, having numerous practical applications.

### Hospitals and Medical Facilities

Medical employees wear passive plastic or paper badges which might have an RFID capability. Upgrading the badge to the reconfigurable interaction badge 102 can provide not only building access but also access to different parts of the hospital with or without tracking. Furthermore, it can be difficult to understand people who are wearing a mask and even more difficult if they are behind a plastic or glass barrier. The interaction badge 102 can help solve this problem by augmenting the speaker's voice with speech-to-text or closed captions functionality. Conversations can be recorded or not at the user's discretion. The interaction badge 102 can provide real time translation as well. The Americans with Disabilities Act (ADA) mandates that medical facilities provide these features when communicating with patients if they have a hearing disability or speak a foreign language. Currently, this is difficult and expensive to accomplish. By using an interaction badge 102, a patient can respond to personnel wearing the interaction badge 102 with a simple hand gesture like thumbs up or thumbs down suggested by an emoji shown on the interaction badge.

In an operating room where all the members of the team make use of interaction badges 102 voice communication within the room is reinforced with speech-to text or closed captioning functionality. Such verification or clarification of what is said can reduce errors and confusion.

### Nursing Homes

Studies have indicated that 30% of people over 70 have hearing disabilities. Providing staff or even patients in a nursing home with interaction badges 102 with speech-to-text or closed captioning functionality can improve care and quality of life at such facilities.

### Corporations

Corporations are beginning to understand their obligations to be more inclusive. The lack of accommodations for employees or customers with disabilities, including hearing disabilities, can lead to expensive lawsuits. Providing employees with interaction badges 102 is one way of addressing the needs of hearing-impaired employees and customers.

### Office Buildings

Most office buildings in major cities have a security desk at the entrance. People with offices in the building have a badge or identity card that gives them access by pressing the badge against an RFID reader. An interaction badge 102 performs in the same fashion but with added security features.

Visitors have to check in at the security desk who check to see if the visitor has a specific invitation to gain access. They must present identification and are often photographed electronically. There is often a line at the desk where the visitor must wait. With a configurable interaction badge 102, the visitor receives an invitation from software supporting the reconfigurable interaction badge 102. The software can also put the invitation on their Calendar and create a guest badge for the building with a time slot, the name and company to be visited and the name, company and other information of the visitor and perhaps their photograph. When the visitor enters the building, the information appears on the reconfigurable interaction badge 102 and the user/visitor can quickly enter the building using the same RFID reader used by the building occupants. All of the information can then be processed and stored by the buildings security system. If the visitor's GPS or MESH functionality is active on their badge or connected device this could be done automatically as they enter the building. Other features can be added by updating the supporting software on the connected device.

### Airplanes

Flight personnel serving passengers on a plane can replace their identification badges with interaction badges 102. In some instances, flight attendants are required to wear masks, which makes it difficult to understand their voice instructions in a noisy environment. Such instructions may be important to safety and must be understood clearly. For instance, the question “Is your safety belt fastened?” could be difficult to be understood by a passenger in a window seat. The interaction badge 102 of the flight attendant can show the question and the passenger can respond with a thumbs up or simply say yes. Similarly, instructions or questions can be shown in multiple languages on the interaction badge 102. In fact, the flight attendant might not have to repeat instructions at each row but merely tap the message on the interaction badge 102 and point at the passenger from whom they require a response.

### Police and EMS

Police, fire, and other emergency response personnel are also required by the ADA to be able to communicate with people who have hearing disabilities or speak a foreign language. In many instances they have no way to meet the requirements. It can be a more difficult environment than the hospital environment because they immediately need a translator or a sign language interpreter and, because of the pressure of time, cannot do that. An interaction badge 102 provides this functionality.

### Home and Family

Another prime application for an interaction badge 102 is within a family. Within an extended family there may be members of the family who are deaf or have hearing difficulties. They tend to be left out of conversations and try to stay involved with lip reading and, of course, hearing aids. An interaction badge 102 with speech-to-text or closed captioning functionality is useful to enable these family members to participate by reading the speech to text display of the interaction badge 102 as conversations occur in real time.

### Encryption and Security

Encryption and security is built into the basic design of the interaction badge 102. When a Bluetooth® connection is made, the signal between the interaction badge and a connected device is automatically uniquely encrypted. The default of the interaction badge 102 is to maximize security. It is at the user's option if they want to alter security settings. The interaction badge 102 voice recognition, speech-to-text, or closed captioning functionality is provided by the badge itself or the connected device, such as a smart phone and does not require connection with Wi-Fi and the Internet to provide its basic functionality. At the user's option they may use cloud functions, including voice recognition.

### Location and Proximity Detection

Using the RFID functionality of the interaction badge 102, as well as any GPS or MESH functionality, the location of wearer can be tracked. In the office or hospital environment this information can be useful to determining who is present in or absent from a location as well as proximity to the location. In the convention or meeting environment, this information can be used to track attendance or business contact. In view of infectious disease concerns, this information can be used to track or otherwise enforce social distancing as well as perform contact tracing.

### Conferences Expos and Meetings

207 million Americans last year were issued temporary paper or plastic badges for conferences expos and meetings. The configurable interaction badge 102 of the present invention can replace those badges with many improved functions including downloading the entry badge and bypassing registration. The functionality of the interaction badge 102 can further be used for tracking the locations of attendees using the RFID, GPS, or MESH functionality of the interaction badge 102 to monitor attendance, capacity, and interactions of attendees with displays, rooms, or other attendees.

To any extent utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may existing in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A reconfigurable interaction badge, the badge comprising:
a display for displaying data;
a processor in electronic communication with the display, the processor configured to provide data for output on the display;
a memory store in electronic communication with the processor and configured to hold instructions and data for execution by the processor;
a power store powering the processor and display;
a radio frequency identification (RFID) transceiver in electronic communication with the processor and configured to transmit identification data;
a short-range wireless transceiver in electronic communication with the processor and configured to transmit and receive data; and
a microphone in electronic communication with the processor and configured to receive audio signals.

2. The interaction badge of claim 1, wherein the display comprises an electronic-paper (e-paper) display.

3. The interaction badge of claim 2, wherein the e-paper display has a refresh rate of at least once per second.

4. The interaction badge of claim 3, wherein the refresh rate is at least 3 times per second.

5. The interaction badge of claim 1, wherein the power store comprises radio frequency energy.

6. The interaction badge of claim 1, wherein the power store is a battery.

7. The interaction badge of claim 6, wherein the battery is a rechargeable battery.

8. The interaction badge of claim 1, where the processor is further configured to log each use of the RFID transceiver and store data in the memory store.

9. The interaction badge of claim 1, wherein the processor and RFID transceiver are configured to conduct financial transactions.

10. The interaction badge of claim 1, further comprising a data port.

11. The interaction badge of claim 1, wherein the processor is further configured to receive speech through the microphone and output text on the display.

12. The interaction badge of claim 11, wherein the output of text comprises:
transmission of audio information received from the microphone to an external connected device for processing and conversion using the short-range wireless transceiver;
receiving text from the external connected device using the short-range wireless transceiver; and
outputting the text on the display.

13. The interaction badge of claim 12, wherein the text received from the external connected device comprises text that is a closed-captioned text conversion of the audio information.

14. The interaction badge of claim 12, wherein the text received from the external connected device comprises text that is a language translation text conversion of the audio information.

15. The interaction badge of claim 1, further comprising a GPS receiver in electronic communication with the processor.

16. The interaction badge of claim 1, further comprising a camera in electronic communication with the processor.

17. The interaction badge of claim 16, wherein the processor is configured to perform object or facial recognition on image data obtained by the camera.

18. The interaction badge of claim 1, wherein the RFID transceiver communicates using Near Field Communication (NFC).

19. The interaction badge of claim 1, further comprising a body holding the display, processor, memory, transceivers, and microphone.

20. The interaction badge of claim 1, further comprising a switch for activating functionality of interaction badge.

21. The interaction badge of claim 1, further comprising a vibration mechanism disposed to cause the badge to vibrate.

22. The interaction badge of claim 1, further comprising an indicator light.

23. The interaction badge of claim 22, wherein the color of the indicator light is variable.

24. The interaction badge of claim 22, wherein the indicator light is comprised of a light emitter disposed inside the interaction badge optically coupled with a light transmission fiber coupled with a light box disposed at a corner of the interaction badge enabling the indicator light to be viewable by the user and by a third party.

25. The interaction badge of claim 1, wherein the microphone is directional and is targeted outwardly from the interaction badge away from a user of the badge enabling receipt of audio from a third party.

26. The interaction badge of claim 1, further comprising a second microphone targeted upwardly toward a mouth of a user of the badge enabling receipt of audio from the user.

27. A method of using a reconfigurable interaction badge, the method comprising:
providing a reconfigurable interaction badge comprising:
a display for displaying data or information;
a processor in electronic communication with the display, the processor configured to provide data for output on the display;
a memory store in electronic communication with the processor and configured to hold instructions and data for execution by the processor;
a power store powering the processor and display;
a radio frequency identification (RFID) transceiver in electronic communication with the processor and configured to transmit identification data;
a short-range wireless transceiver in electronic communication with the processor and configured to transmit and receive data;
a microphone in electronic communication with the processor and configured to receive audio signals; and
uploading data into the memory store for execution by the processor to display data or information on the display; and
displaying data or information on the display.

28. The method of claim 27, wherein the data includes one or more of: a name, a photo, a company affiliation, a graphic, text, a speech to text display, and a speech to text language translation.

29. The method of claim 27, further comprising a data port in electronic communication with the processor and configured to transfer data to and from the processor, and wherein the uploading is performed using the data port.

30. The method of claim 27, wherein the uploading is performed using the short-range wireless transceiver.

31. The method of claim 27, further comprising:
receiving, on the RFID transceiver, an inquiry by a RFID reader; and
transmitting, in response to the inquiry, identification data.

32. The method of claim 31, further comprising logging the inquiry and storing a log in the memory store.

33. The method of claim 32, further comprising outputting the log from the reconfigurable interaction badge.

34. The method of claim 33, further comprising a data port in electronic communication with the processor and configured to transfer data to and from the processor, and wherein the outputting is performed using the data port.

35. The method of claim 33, wherein the outputting is performed using the short-range wireless transceiver.

36. The method of claim 27, further comprising:
sending an inquiry via the RFID transceiver for identification information;
receiving, in response to the inquiry, identification information; and
storing, in the memory store, the received identification information.

37. The method of claim 36, further comprising outputting the stored received identification information.

38. The method of claim 37, further comprising a data port in electronic communication with the processor and configured to transfer data to and from the processor, and wherein the outputting is performed using the data port.

39. The method of claim 37, wherein the outputting is performed using the short-range wireless transceiver.

40. The method of claim 27, further comprising:
receiving audio information on the microphone; and
outputting the data or information as text on the display.

41. The method of claim 40, wherein outputting text comprises:
transmitting audio information received from the microphone to an external connected device, using the short-range wireless transceiver, for processing and conversion;
receiving a text conversion from the external connected device using the short-range wireless transceiver; and
outputting the data or information as the text conversion on the display.

42. The method of claim 41, wherein the text conversion received from the external connected device comprises text that is a closed-captioned text conversion of the audio information.

43. The method of claim 41, wherein the text conversion received from the external connected device comprises text that is a language translation text conversion of the audio information from a first language of the audio information to a second language different from the first language for the text conversion.
